(19) United States
(12) Patent Application Publication
(10) Pub. No.: US 2017/0169795 A1
(43) Pub. Date: Jun. 15, 2017

(54) DISPLAY BRIGHTNESS CONTROL METHODS AND ELECTRONIC EQUIPMENT

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Yantong CHE, Beijing (CN)

(21) Appl. No.: 15/240,355

(22) Filed: Aug. 18, 2016

Related U.S. Application Data
(63) Continuation of application No. PCT/CN2016/089193, filed on Jul. 7, 2016.

(30) Foreign Application Priority Data
Dec. 9, 2015 (CN) 201510908345.1

(51) Int. Cl. G09G 5/10

(52) U.S. Cl. CPC G09G 5/10; G09G 2330/021; G09G 2320/08; G09G 2360/16; G09G 2320/0646; G09G 2320/0261

(57) ABSTRACT

The present disclosure relates to a method and device for controlling brightness of a display screen, applied to a terminal, including: obtaining remaining safe quantity of electricity of the terminal and obtaining a remaining duration of a video when the video is played in full screen at the terminal; determining a target brightness value of the display screen when the playing of the video corresponding to the remaining duration in full screen state is completed, according to the remaining safe quantity of electricity; and regulating a brightness value of the display screen of the terminal to the target brightness value. The method can realize that screen brightness values corresponding to a video available for the user to watch are automatically set without quitting the full screen mode during the video is played in full screen.

### CROSS REFERENCE TO RELATED APPLICATION

This application is a continuation of International PCT Patent Application No. PCT/CN2016/089193, filed Jul. 7, 2016 (attached hereto as an Appendix), and claims benefit/priority of Chinese patent application entitled “DISPLAY BRIGHTNESS CONTROL METHODS AND ELECTRONIC EQUIPMENT”, application number 201510908345.1, filed with the State Intellectual Property Office of China on Dec. 9, 2015, which are all incorporated herein by reference in entirety. A copy of the originally filed PCT application is attached to the specification as Appendix A.

### FIELD OF TECHNOLOGY

The present disclosure relates to the technical field of equipment controlling, and in particular, to a method and device for controlling brightness of display screen.

### BACKGROUND

With development of science and technology, various portable mobile terminals are more and more widely used, with which people may browse web pages, watch videos, play games, communicate or photograph and so on. These mobile terminals are generally continuously powered with built-in batteries, thus the endurance of the batteries will impact the usage of the mobile terminals.

Taking mobile phone as an example, no remaining safe quantity of electricity will be shown on the screen when a user typically watches videos in full screen using a mobile phone, and the user will not frequently switch out from the full screen to note how much quantity of electricity is remained. Thus, the quantity of electricity in the mobile phone will be dramatically lost when a video is played in full screen, and once the quantity of electricity in the mobile phone is lower, the user has to stop the video to maintain smooth communication, thereby affecting watching the video.

### SUMMARY

To overcome the problems existing in the related technique, the present disclosure provides a method and electronic device for controlling brightness of a display screen.

According to a first aspect of the embodiments of the present disclosure, a method for controlling brightness of a display screen applied to a terminal is provided, including:

obtaining remaining safe quantity of electricity of the terminal and obtaining a remaining duration of a video when the video is played in full screen at the terminal;

determining a target brightness value of the display screen when the playing of the video corresponding to the remaining duration in full screen state is completed, according to the remaining safe quantity of electricity; and

regulating a brightness value of the display screen of the terminal to the target brightness value.

Alternatively, the step of determining a target brightness value of the display screen when the playing of the video corresponding to the remaining duration in full screen is completed, includes:

calculating unit power consumption when the playing of the video corresponding to the remaining duration is completed using the remaining safe quantity of electricity; and

searching a brightness value corresponding to the unit power consumption in corresponding relations between preset unit power consumption and brightness values as the target brightness value.

Alternatively, the method further includes:

obtaining a current brightness value of the display screen;

judging whether the current brightness value is greater than the target brightness value; and

executing the step of regulating a brightness value of the display screen of the terminal to the target brightness value when the current brightness value is greater than the target brightness value.

Alternatively, the step of regulating a brightness value of the display screen of the terminal to the target brightness value, includes:

switching the brightness value of the display screen from the current brightness value to the target brightness value; or,

calculating a difference of brightness between the current brightness value and the target brightness value, determining a preset brightness regulating quantity corresponding to the difference of brightness, and regulating the brightness value of the display screen from the current brightness value to the target brightness value according to the brightness regulating quantity.

Alternatively, the method further includes:

recording a current brightness value of the display screen as a history brightness value;

judging whether the terminal ends a full-screen play after the brightness value of the display screen of the terminal is regulated to the target brightness value; and

regulating the brightness value of the display screen of the terminal from the target brightness value to the history brightness value when the terminal ends the full-screen play.

According to a second aspect of the embodiments of the present disclosure, the embodiment of the present disclosure provides a non-volatile computer-readable storage medium stored with computer executable instructions, the computer executable instructions may perform any one of the method described above in the disclosure.

According to a third aspect of the embodiments of the present disclosure, the embodiment of the present disclosure provides an electronic device, including: at least one processor; and a memory; wherein, the memory is communicably connected with the at least one processor for storing instructions executed by the at least one processor, the computer executable instructions may perform any one of the method described above in the disclosure.

It should be understood that, the above general description and detailed description hereinafter are merely exemplary and explanatory, which are not a limit to the present disclosure.

### BRIEF DESCRIPTION OF THE DRAWINGS

One or more embodiments are illustrated by way of examples, and not by limitation, in the figures of the accompanying drawings, wherein elements having the same reference number designations represent like elements throughout. The drawings are not to scale, unless otherwise disclosed.

FIG. 1 is a flowchart illustrating a method for controlling brightness of a display screen according to an embodiment;

FIG. 2 is a detailed schematic flowchart illustrating step S102 in FIG. 1;

FIG. 3 is a flowchart illustrating another method for controlling brightness of a display screen according to an embodiment;

FIG. 4 is a flowchart illustrating another method for controlling brightness of a display screen according to an embodiment;

FIG. 5 is a schematic diagram of structure illustrating a device for controlling brightness of a display screen according to an embodiment;

FIG. 6 is a schematic diagram of structure illustrating a device for controlling brightness of a display screen according to an embodiment;

FIG. 7 is a schematic diagram of structure illustrating a device for controlling brightness of a display screen according to an embodiment;

FIG. 8 is a structural schematic diagram of an electronic device provided by an embodiment of the disclosure.

### DETAILED DESCRIPTION

Embodiments are illustrated in detail herein, with examples indicated in drawings. When the following descriptions involve drawings, unless specially indicated, the same numbers in different drawings indicate the same or similar element. The implementations described in the following embodiments do not represent all implementations consistent with the present disclosure. On the contrary, they are merely examples of devices and methods consistent with some aspects of the present disclosure, as expatiated in the appended claims.

The method for controlling brightness of a display screen provided by the embodiments of the present disclosure may be applied to general portable terminals, for example, equipments such as mobile phone, tablet computer or e-book, etc. Independently power batteries are typically provided in these portable terminals to support the portable terminals to be normally operated at outdoor.

FIG. 1 is a flowchart illustrating a method for controlling brightness of a display screen according to an embodiment.

As shown in FIG. 1, the method may include the following steps.

Step S101: remaining safe quantity of electricity of a terminal is obtained, and a remaining duration of a video is obtained, when the video is played in full screen at the terminal.

In the embodiment of the present disclosure, the remaining safe quantity of electricity may be all remaining quantity of electricity of the terminal, and of course may also be the quantity of electricity obtained from all remaining quantity of electricity of the terminal minus 3% of total quantity of electricity.

The time at which the video is played may be obtained by a playing progress bar of the video.

Step S102: a target brightness value of the display screen when the playing of the video corresponding to the remaining duration in full screen is completed is determined, according to the remaining safe quantity of electricity.

The target brightness value refers to a brightness value when the video corresponding to the remaining duration is played in full screen, powered by the remaining safe quantity of electricity. In other words, when the video with the remaining duration is played in full screen according to the target brightness value, the remaining safe quantity of electricity is completely consumed after the playing of the video is ended.

When the target brightness value is determined, history records of quantity of electricity consumed by different brightness values in different durations can be pre-obtained, and then the target brightness value is calculated according to the remaining safe quantity of electricity and the remaining duration.

Step S103: a brightness value of the display screen of the terminal is regulated to the target brightness value.

As can be known from the above step S102 that the remaining safe quantity of electricity can ensure that the playing of the video with the remaining duration will complete using the target brightness value, thus a brightness value of the display screen can be directly regulated to the target brightness value in the step.

In another embodiment of the present disclosure, the above step S103 may adopt the following modes:

Mode one: a brightness value of the display screen is switched from the current brightness value to the target brightness value.

Mode two: a difference of brightness between the current brightness value and the target brightness value is calculated, a preset brightness regulating quantity corresponding to the difference of brightness is determined, and the brightness value of the display screen is regulated from the current brightness value to the target brightness value according to the brightness regulating quantity.

According to the method provided by the embodiments of the present disclosure, when a video is played in full screen at a terminal, remaining safe quantity of electricity of the terminal and a remaining duration of the video that is played can be automatically obtained, then a target brightness value when the playing of the video with the remaining duration is completed using the remaining safe quantity of electricity is determined, and finally, the brightness value of the display screen of the terminal is automatically set to the target brightness value.

The method can realize that screen brightness values corresponding to a video available for the user to watch are automatically set without quitting the full screen mode during the video is played in full screen. The method can solve the problem that the terminal automatically powers off or shows low battery alarm when the playing of a video is not completed due to not checking remaining quantity of electricity timely when the user is watching the video played in full screen, without need of user's manual operation.

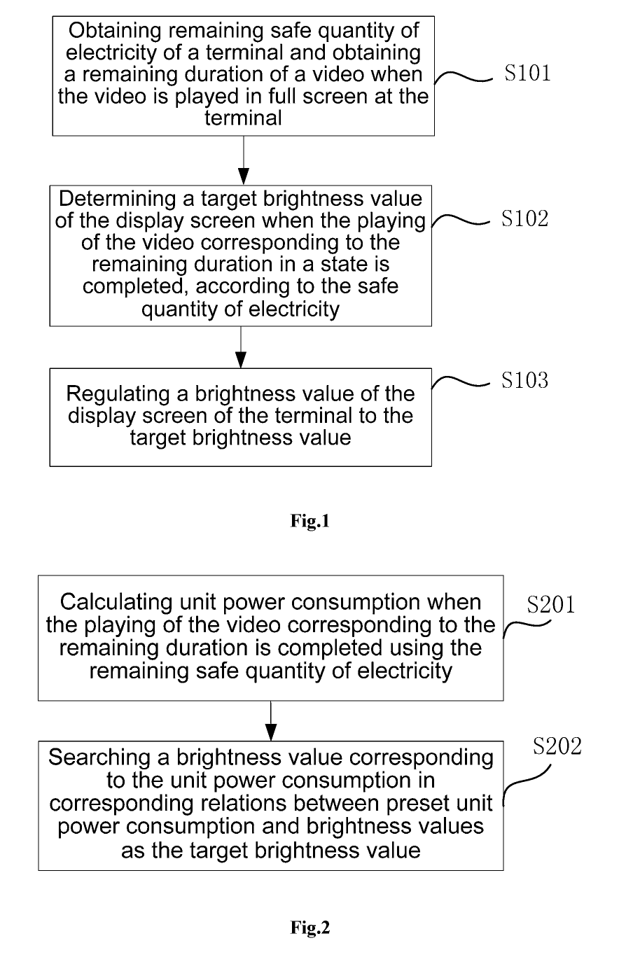

In an embodiment of the present disclosure, as shown in FIG. 2, the above step S102 may include the following steps.

Step S201: unit power consumption when the playing of the video corresponding to the remaining duration is completed using the remaining safe quantity of electricity is calculated.

In the step, the remaining safe quantity of electricity is allocated to the remaining duration according to the principle of time allocation, thus power consumption in unit time of per second or per minute can be obtained when the video is played.

Taking the remaining safe quantity of electricity of 500 mA as an example, the remaining duration is 50 minutes, then the unit power consumption will be 10 mA/min.

Step S202: a brightness value corresponding to the unit power consumption is searched in corresponding relations between preset unit power consumption and brightness values as the target brightness value.

In the embodiment of the present disclosure, corresponding relations between unit power consumption and brightness values may be pre-obtained though experiments. Taking the aforesaid remaining safe quantity of electricity of 500 mA as an example for illustrating, supposing when a video is displayed according to the brightness value of 8, the unit power consumption is 15 mA; and when a video is displayed according to the brightness value of 6, the unit power consumption is 10 mA, then apparently, the target brightness value is required to be 6 for completing the playing of the video with the remaining duration.

Therefore, in the step, the target brightness value corresponding to the unit power consumption can be obtained by directly searching in the corresponding relations.

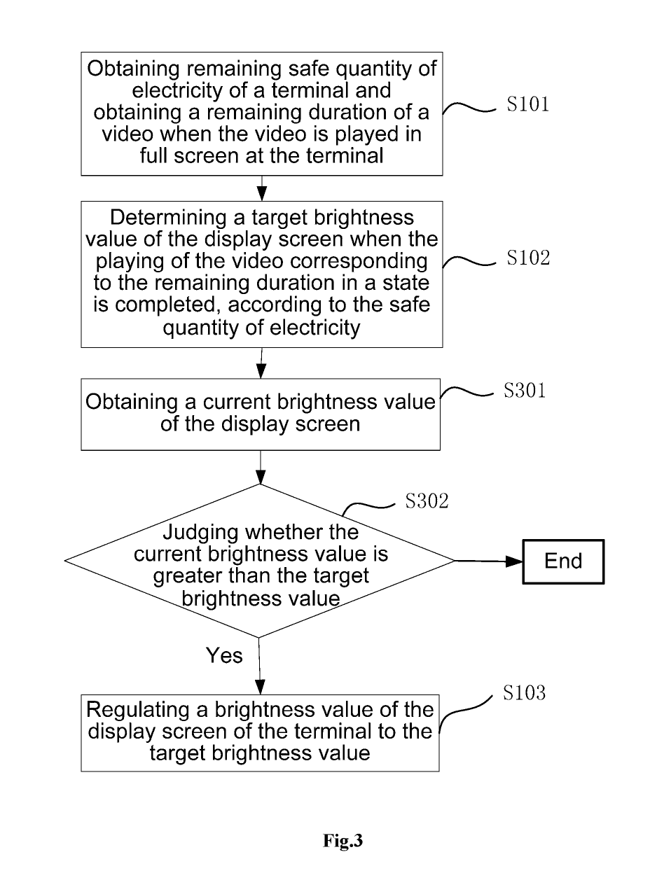

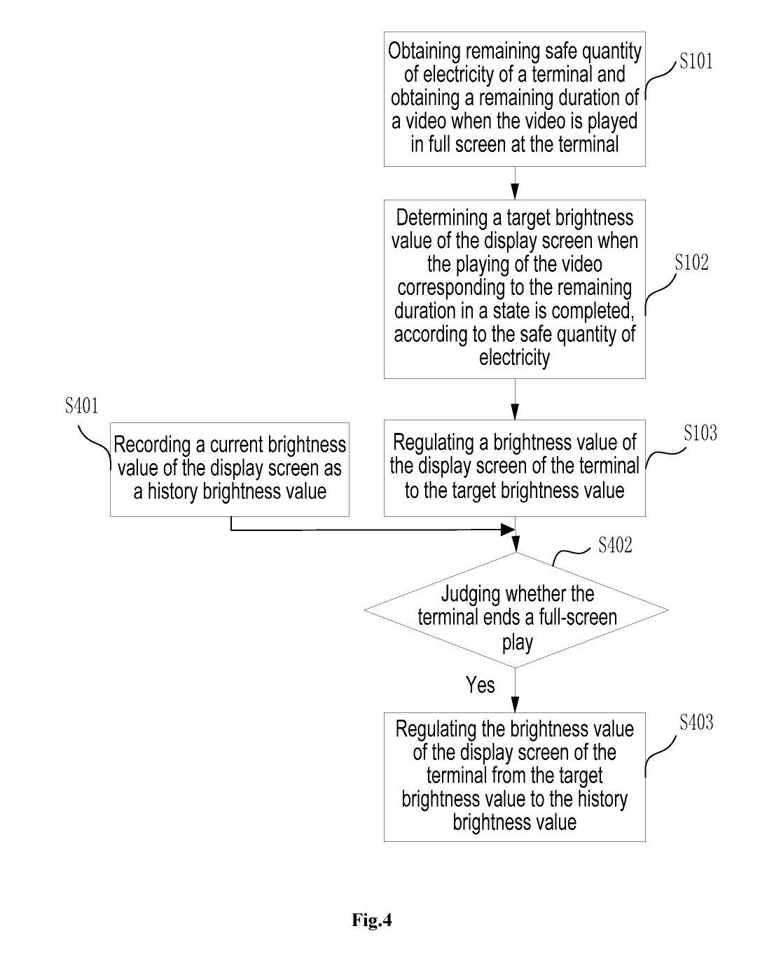

After the target brightness value is obtained according to the above embodiments, the brightness value of the display screen of the terminal can be directly regulated, but if the brightness value of the display screen is just the target brightness value, the brightness value of the display screen does not required to be regulated apparently. For this, as shown in FIG. 3, the embodiment of the present disclosure further provides a method for controlling brightness of a display screen, wherein the method may further includes the following steps based of the embodiment shown in FIG. 1.

Step S301: a current brightness value of the display screen is obtained.

Step S302: whether the current brightness value is greater than the target brightness value is judged.

When the current brightness value is greater than the target brightness value, the above step S103 is executed.

In the embodiment of the present disclosure, because the current brightness value is greater than the target brightness value, the remaining safe quantity of electricity will not ensure that the playing of the video corresponding to the remaining duration can be completed if the brightness is not regulated. However, in a case that the current brightness value is lower than the target brightness value, the playing of the video corresponding to the remaining duration can still be completed using the remaining safe quantity of electricity at the current lower brightness value even though the user does not regulate the brightness at this moment.

Furthermore, if the user suddenly quits from the full screen during playing, the target brightness value obtained by calculation described above will not comply with the current environment. For this, in another embodiment of the present invention, as shown in FIG. 4, the method may further include the following steps.

Step S401: a current brightness value of the display screen is recorded as a history brightness value.

Step S402: whether the terminal ends a full-screen play is judged after the brightness value of the display screen of the terminal is regulated to the target brightness value.

When the terminal ends the full-screen play, step S403 is executed, otherwise the procedure is ended.

Step S403: the brightness value of the display screen of the terminal is regulated from the target brightness value to the history brightness value.

Because the target brightness value is determined for completeness of playing the remaining duration, the brightness value is usually lower. In the embodiment shown in FIG. 3, when the playing of the video with the remaining duration is not completed yet, the brightness value of the display screen of the terminal may further be regulated again to the history brightness value, so as to prevent an operation of regulating the brightness value back to the history brightness value when using the terminal, thereby improving the convenience.

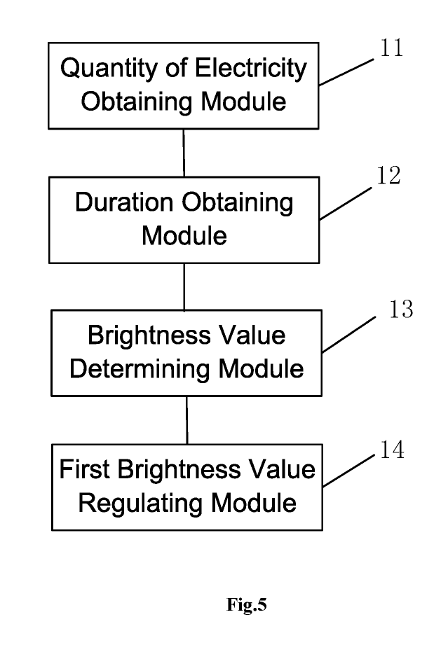

FIG. 5 is a schematic diagram of structure illustrating a device for controlling brightness of a display screen according to an embodiment. As shown in 5, the device may include:

A quantity of electricity obtaining module 11, configured to obtain remaining safe quantity of electricity of a terminal when a video is played in full screen at the terminal;

A duration obtaining module 12, configured to obtain a remaining duration of the video when the video is played in full screen at the terminal;

A brightness value determining module 13, configured to determine a target brightness value of the display screen when the video corresponding to the remaining duration is played in full screen according to the remaining safe quantity of electricity; and

A first brightness value regulating module 14, configured to regulate the brightness value of the display screen of the terminal to the target brightness value.

According to the device provided by the embodiment of the present disclosure, when a video is played in full screen at a terminal, remaining safe quantity of electricity of the terminal and remaining duration of the video that is played can be automatically obtained, then a target brightness value when the playing of the video with the remaining duration is completed using the remaining safe quantity of electricity is determined, and finally, the brightness value of the display screen of the terminal is automatically set to the target brightness value.

The device can realize that screen brightness values corresponding to a video available for the user to watch are automatically set without quitting the full screen mode during the video is played in full screen. The method can solve the problem that the terminal automatically powers off or shows low battery alarm when the playing of a video is not completed due to not checking remaining quantity of electricity timely when the user is watching the video played in full screen, without need of user's manual operation.

In an embodiment of the present disclosure, the brightness value determining module 13 may include:

A calculating submodule, configured to calculate unit power consumption when the playing of the video corresponding to the remaining duration is completed using the remaining safe quantity of electricity; and

A searching submodule, configured to search a brightness value corresponding to the unit power consumption in corresponding relations between preset unit power consumption and brightness values as the target brightness value.

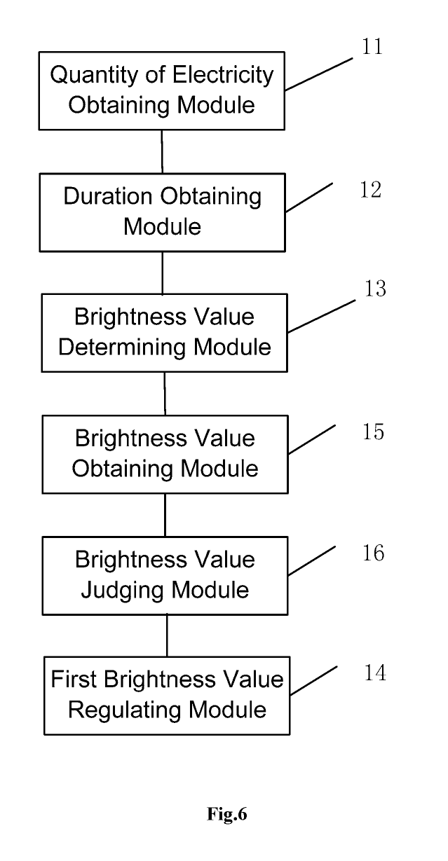

In another embodiment of the present disclosure, as shown in FIG. 6, the device may further include:

A brightness value obtaining module 15, configured to obtain a current brightness value of the display screen;

A brightness value judging module 16, configured to judge whether the current brightness value is greater than the target brightness value; and

The first brightness value regulating module 14, further configured to regulate the brightness value of the display screen of the terminal to the target brightness value when the current brightness value is greater than the target brightness value.

In another embodiment of the present disclosure, the brightness value regulating module may include:

A brightness value switching submodule, configured to switch the brightness value of the display screen from the current brightness value to the target brightness value; or,

A difference calculating submodule, configured to calculate a difference of brightness between the current brightness value and the target brightness value; a regulating quantity determining submodule, configured to determine a preset brightness regulating quantity corresponding to the difference of brightness; and a brightness value regulating submodule, configured to regulate the brightness value of the display screen from the current brightness value to the target brightness value according to the brightness regulating quantity.

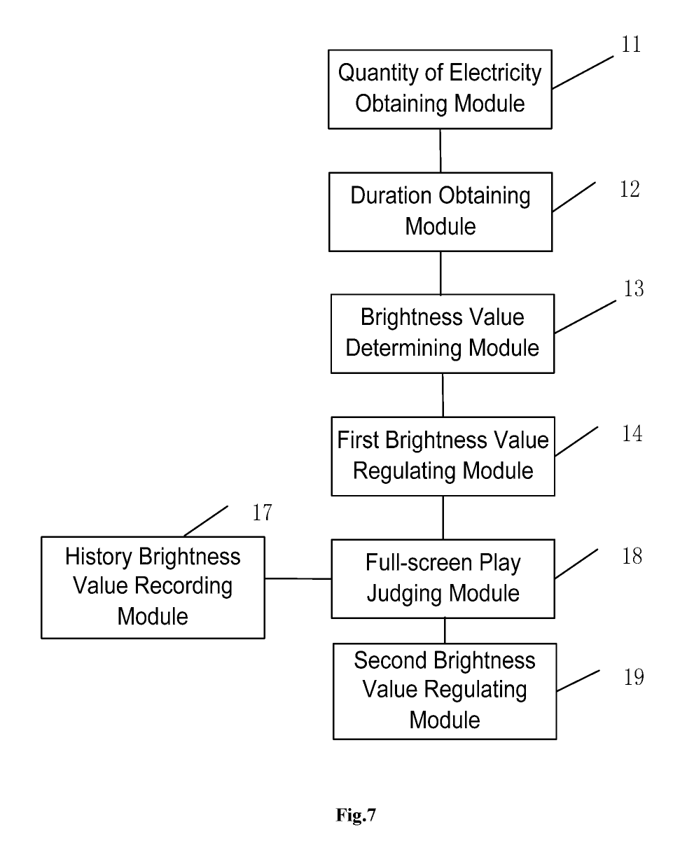

In another embodiment of the present disclosure, as shown in FIG. 7, the device may further include:

A history brightness value recording module 17, configured to record a current brightness value of the display screen as a history brightness value;

A full-screen play judging module 18, configured to judge whether the terminal ends a full-screen play after the brightness value of the display screen of the terminal is regulated to the target brightness value; and

A second brightness value regulating module 19, configured to regulate the brightness value of the display screen of the terminal from the target brightness value to the history brightness value when the terminal ends the full-screen play.

Furthermore, in another embodiment of the present disclosure, a terminal is further provided, wherein the terminal may include the device for controlling brightness of a display screen as described in any of the aforesaid embodiments shown in FIGS. 5-7.

Embodiments of the present disclosure further provide a non-volatile computer-readable storage medium, the non-volatile computer-readable storage medium is stored with computer executable instructions, the computer executable instructions perform the method for controlling brightness of a display screen in any embodiment described above.

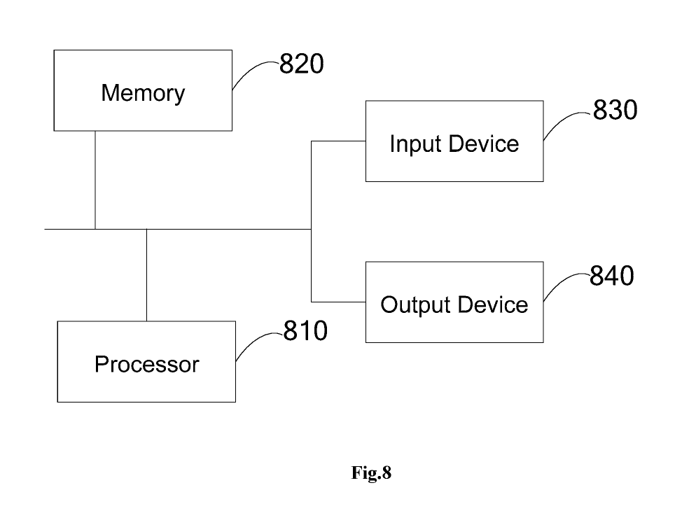

FIG. 8 is a schematic diagram of hardware structure of an electronic device used to perform the method for controlling brightness of a display screen according to an embodiment of the present disclosure, as shown in FIG. 8, the device includes:

One or more processors 810 and a memory 820, FIG. 8 illustrates one processor 810 as an example.

The device may further include an input device 830 and an output device 840.

The processor 810, the memory 820, the input device 830 and the output device 840 may be connected with each other through bus or other forms of connections. FIG. 8 illustrates bus connection as an example.

As a non-volatile computer-readable storage medium, the memory 820 may store non-volatile software program, non-volatile computer executable program and modules, such as program instructions/modules corresponding to the method described above according to the embodiments of the disclosure (for example, the quantity of electricity obtaining module 11, the duration obtaining module 12, the brightness value determining module 13, and the first brightness value regulating module 14, as illustrated in FIG. 5). By executing the non-volatile software program, instructions and modules stored in the memory 820, the processor 810 may perform various functional applications of the server and data processing, that is, the method described above according to the above mentioned embodiments.

The memory 820 may include a program storage area and a data storage area, wherein, the program storage area may be stored with the operating system and applications which are needed by at least one functions, and the data storage area may be stored with data which is created according to use of the device described above. Further, the memory 820 may include a high-speed random access memory, and may further include non-volatile memory, such as at least one of disk memory device, flash memory device or other types of non-volatile solid state memory device. In some embodiments, optionally, the memory 820 may include memory provided remotely from the processor 810, and such remote memory may be connected with the device described above through network connections, the examples of the network connections may include but not limited to internet, intranet, LAN (Local Area Network), mobile communication network or combinations thereof.

The input device 830 may receive inputted number or character information, and generate key signal input related to the user settings and functional control of the device described above. The output device 840 may include a display device such as a display screen.

The above one or more modules may be stored in the memory 820, when these modules are executed by the one or more processors 810, the method described above according to any one of the above mentioned method embodiments may be performed.

The above product may perform the methods provided in the embodiments of the disclosure, include functional modules corresponding to these methods and advantageous effects. Further technical details which are not described in detail in the present embodiment may refer to the method provided according to embodiments of the disclosure.

The electronic device in the embodiment of the present disclosure exists in various forms, including but not limited to:

(1) Mobile communication device, characterized in having a function of mobile communication mainly aimed at providing speech and data communication, wherein such terminal includes: smart phone (such as iPhone), multimedia phone, functional phone, low end phone and the like;

(2) Ultra mobile personal computer device, which falls in a scope of personal computer, has functions of calculation and processing, and generally has characteristics of mobile internet access, wherein such terminal includes: PDA, MID and UMPC devices, such as iPad;

(3) Portable entertainment device, which can display and play multimedia contents, and include audio or video player (such as iPod), portable game console, E-book and smart toys and portable vehicle navigation device;

(4) Server, an device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) Other electronic devices having a function of data interaction.

The above mentioned examples for the device are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of software product which can be stored in a computer-readable storage medium, such as ROM/RAM, magnetic disk and compact disc, and includes several instructions for allowing a computer device (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for controlling brightness of a display screen, comprising:
at a terminal,
obtaining remaining safe quantity of electricity of the terminal and obtaining a remaining duration of a video when the video is played in full screen at the terminal;
determining a target brightness value of the display screen when the playing of the video corresponding to the remaining duration in full screen state is completed, according to the safe quantity of electricity; and
regulating a brightness value of the display screen of the terminal to the target brightness value.

2. The method for controlling brightness of a display screen according to claim 1, wherein, the step of determining a target brightness value of the display screen when the playing of the video corresponding to the remaining duration in full screen state is completed comprises:
calculating unit power consumption when the playing of the video corresponding to the remaining duration is completed using the remaining safe quantity of electricity; and
searching a brightness value corresponding to the unit power consumption in corresponding relations between preset unit power consumption and brightness values as the target brightness value.

3. The method for controlling brightness of a display screen according to claim 1, further comprising:
obtaining a current brightness value of the display screen;
judging whether the current brightness value is greater than the target brightness value; and
executing the step of regulating a brightness value of the display screen of the terminal to the target brightness value when the current brightness value is greater than the target brightness value.

4. The method for controlling brightness of a display screen according to claim 3, wherein, the step of regulating a brightness value of the display screen of the terminal to the target brightness value comprises:
switching the brightness value of the display screen from the current brightness value to the target brightness value; or,
calculating a difference of brightness between the current brightness value and the target brightness value, determining a preset brightness regulating quantity corresponding to the difference of brightness, and regulating the brightness value of the display screen from the current brightness value to the target brightness value according to the brightness regulating quantity.

5. The method for controlling brightness of a display screen according to claim 1, further comprising:
recording a current brightness value of the display screen as a history brightness value;
judging whether the terminal ends a full-screen play after the brightness value of the display screen of the terminal is regulated to the target brightness value; and
regulating the brightness value of the display screen of the terminal from the target brightness value to the history brightness value when the terminal ends the full-screen play.

6. A non-volatile computer-readable storage medium stored with computer executable instructions that, when executed by an electronic device, cause the electronic device to:
obtain remaining safe quantity of electricity of the terminal and obtaining a remaining duration of a video when the video is played in full screen at the terminal;
determine a target brightness value of the display screen when the playing of the video corresponding to the remaining duration in full screen state is completed, according to the safe quantity of electricity; and
regulate a brightness value of the display screen of the terminal to the target brightness value.

7. The non-volatile computer-readable storage medium according to claim 6, wherein, the step of determining a target brightness value of the display screen when the playing of the video corresponding to the remaining duration in full screen state is completed comprises:
calculating unit power consumption when the playing of the video corresponding to the remaining duration is completed using the remaining safe quantity of electricity; and
searching a brightness value corresponding to the unit power consumption in corresponding relations between preset unit power consumption and brightness values as the target brightness value.

8. The non-volatile computer-readable storage medium according to claim 6, wherein, the electronic device is further caused to:
obtain a current brightness value of the display screen;
judge whether the current brightness value is greater than the target brightness value; and
execute the step of regulating a brightness value of the display screen of the terminal to the target brightness value when the current brightness value is greater than the target brightness value.

9. The non-volatile computer-readable storage medium according to claim 8, wherein, the step of regulating a brightness value of the display screen of the terminal to the target brightness value comprises:
switching the brightness value of the display screen from the current brightness value to the target brightness value; or,
calculating a difference of brightness between the current brightness value and the target brightness value, determining a preset brightness regulating quantity corresponding to the difference of brightness, and regulating the brightness value of the display screen from the current brightness value to the target brightness value according to the brightness regulating quantity.

10. The non-volatile computer-readable storage medium according to claim 6, wherein, the electronic device is further caused to:
record a current brightness value of the display screen as a history brightness value;
judge whether the terminal ends a full-screen play after the brightness value of the display screen of the terminal is regulated to the target brightness value; and
regulate the brightness value of the display screen of the terminal from the target brightness value to the history brightness value when the terminal ends the full-screen play.

11. An electronic device, comprising:
at least one processor; and
a memory, communicably connected with the at least one processor for storing instructions executed by the at least one processor,
wherein the execution of the instructions by the at least one processor causes the at least one processor to:
obtain remaining safe quantity of electricity of the terminal and obtaining a remaining duration of a video when the video is played in full screen at the terminal;
determine a target brightness value of the display screen when the playing of the video corresponding to the remaining duration in full screen state is completed, according to the safe quantity of electricity; and
regulate a brightness value of the display screen of the terminal to the target brightness value.

12. The electronic device according to claim 11, wherein, the step of determining a target brightness value of the display screen when the playing of the video corresponding to the remaining duration in full screen state is completed comprises:
calculating unit power consumption when the playing of the video corresponding to the remaining duration is completed using the remaining safe quantity of electricity; and
searching a brightness value corresponding to the unit power consumption in corresponding relations between preset unit power consumption and brightness values as the target brightness value.

13. The electronic device according to claim 11, wherein, the at least one processor is further caused to:
obtain a current brightness value of the display screen;
judge whether the current brightness value is greater than the target brightness value; and
execute the step of regulating a brightness value of the display screen of the terminal to the target brightness value when the current brightness value is greater than the target brightness value.

14. The electronic device according to claim 13, wherein, the step of regulating a brightness value of the display screen of the terminal to the target brightness value comprises:
switching the brightness value of the display screen from the current brightness value to the target brightness value; or,
calculating a difference of brightness between the current brightness value and the target brightness value, determining a preset brightness regulating quantity corresponding to the difference of brightness, and regulating the brightness value of the display screen from the current brightness value to the target brightness value according to the brightness regulating quantity.

15. The electronic device according to claim 11, wherein, the at least one processor is further caused to:
record a current brightness value of the display screen as a history brightness value;
judge whether the terminal ends a full-screen play after the brightness value of the display screen of the terminal is regulated to the target brightness value; and
regulate the brightness value of the display screen of the terminal from the target brightness value to the history brightness value when the terminal ends the full-screen play.
